(19) United States
(12) Patent Application Publication
(10) Pub. No.: US 2018/0077867 A1
(43) Pub. Date: Mar. 22, 2018

(54) RECIPROCATING HAND HELD MOTOR TOOL FOR THINNING FRUIT

(71) Applicant: Phillip John Miller, Manistee, MI (US)

(72) Inventor: Phillip John Miller, Manistee, MI (US)

(21) Appl. No.: 15/711,401

(22) Filed: Sep. 21, 2017

Related U.S. Application Data
(60) Provisional application No. 62/397,941, filed on Sep. 22, 2016.

(51) Int. Cl. A01D 46/247; A01D 46/253

(52) U.S. Cl. CPC A01D 46/247; A01D 46/253

(57) ABSTRACT

Disclosed herein is a handheld apparatus for thinning fruit such as apples, pears, cherries, plums, peaches and the like from the branches of fruit trees. The apparatus includes a handheld reciprocating motor unit and a hook shaft detachably secured to the motor unit. The hook shaft terminates in a hook configured to fit around the stem of the fruit.

### CLAIM OF PRIORITY

The present application claims priority to and the benefit of the filing date of U.S. provisional application 62/397,941 filed on Sep. 22, 2016.

### TECHNICAL FIELD

The present invention relates in general to handheld devices for thinning and harvesting fruit trees.

### BACKGROUND

Harvesting fruits such as apples, cherries, pears, plums, apricots, peaches, etc. from fruit trees is often done by hand from ladders, or with long-handled tools with small baskets, rakes, clamping jaws, and the like for plucking, twisting, or pulling the fruit from the branches. Vacuum pickers are also known.

Prior tools are believed to be unsuitable or awkward for thinning small, unripe fruits from among closely-growing immature fruits on fruit trees. Accordingly, most thinning of fruit trees is done by hand, or with improvised crude tools such as lengths of hose or small plastic bats or clubs, which is time consuming and laborious, especially when the person thinning the fruit is on a ladder, and which tends to damage the adjacent un-thinned fruit. In some cases it is known to “thin” the fruit with the application of chemical sprays, a practice not suitable for organic farming methods.

### SUMMARY

The present invention is a handheld fruit-thinning tool that extends the user's reach, and that quickly and easily removes small unripe fruit from a fruit tree branch with precision, even when the fruit is firmly attached to the branch at the stem, and with minimal trauma to closely adjacent fruit on the branch.

In accordance with one aspect of the disclosed embodiments, an apparatus for thinning fruit includes a handheld reciprocating motor unit with a stationary hand grip and a linearly reciprocating tool holder for detachably receiving and reciprocating an elongated hook shaft.

In accordance with another aspect of the disclosed embodiments, the hook shaft includes a lower tool connector portion, and a terminal hook whose bend is approximately 180 degrees.

In accordance with another aspect of the disclosed embodiments, the hook shaft includes a base portion including the tool connector portion, and an upper shaft including the hook and removably secured to a socket in the base portion.

In accordance with another aspect of the disclosed embodiments, multiple upper shafts of different length are supplied with a single base portion, in order to allow the user to adjust the reach of the tool.

In accordance with another aspect of the disclosed embodiments, the handheld motor unit is a commercially available type of reciprocating one-handed hand saw unit or equivalent with a collet for receiving detachable blades (e.g., Sawzall®, Hackzall®), and the base portion of the hook shaft is configured to be readily attached and detached from the collet of the reciprocating hand saw.

In accordance with another aspect of the invention, the handheld motor unit defines a grip axis and a reciprocating tool axis offset with respect to the grip axis. In a further aspect the reciprocating tool axis is also angled (non-parallel) with respect to the grip axis. In a further aspect the grip axis is generally vertical when in use, and the reciprocating tool axis is set at an acute upward angle, for example on the order of 30-45 degrees inclined forward from vertical.

These and other embodiments will be described in additional detail hereinafter.

### BRIEF DESCRIPTION OF THE DRAWINGS

The description herein makes reference to the accompanying drawings wherein like reference numerals refer to like parts throughout the several views, and wherein:

FIG. 1 is a perspective view of a fruit thinning tool according to one embodiment, shown engaging a fruit to be thinned from a fruit tree branch.

FIG. 2 is a perspective view of the hook shaft portion of the fruit thinning tool of FIG. 1.

FIG. 3 is a detail of the lower end of a two-piece embodiment of the hook shaft portion of the tool of FIG. 1, in exploded assembly view.

FIG. 4 is a top plan view of the base portion of the two-piece hook shaft of FIG. 3.

FIG. 5 is a left side elevation view of the base portion of the two-piece hook shaft of FIG. 3, the right side being identical in mirror.

FIG. 6 is an outer end view of the base portion of the two-piece hook shaft.

FIG. 7 is an inner end view of the base portion of the two-piece hook shaft.

### DETAILED DESCRIPTION

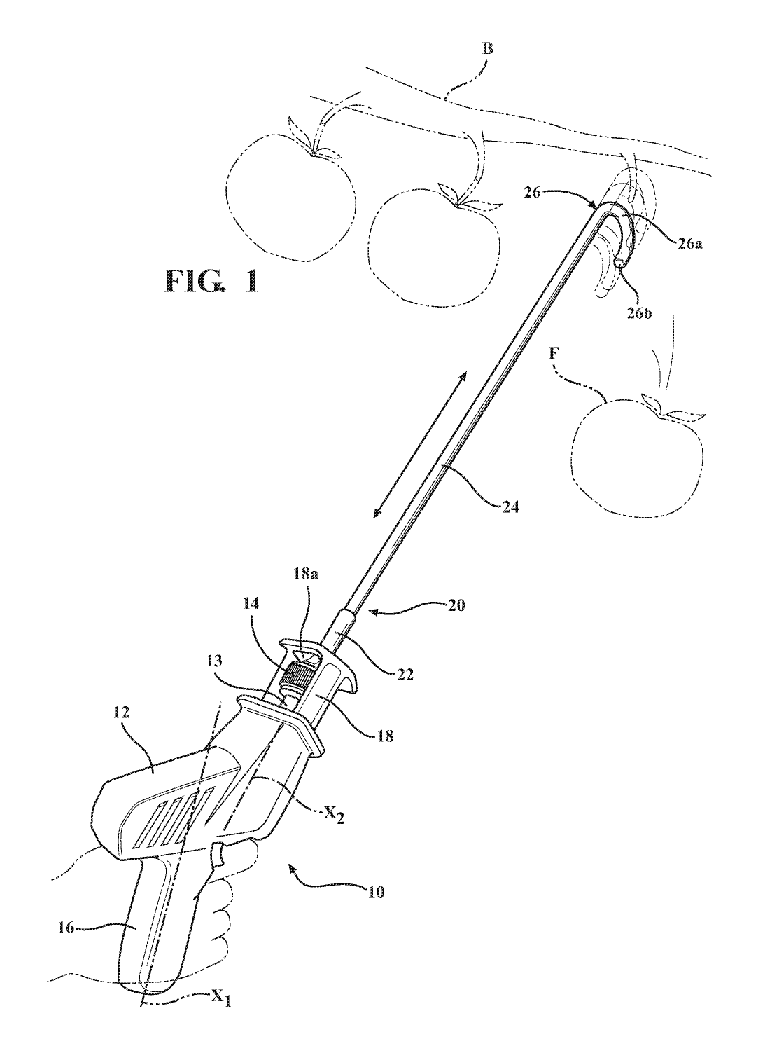

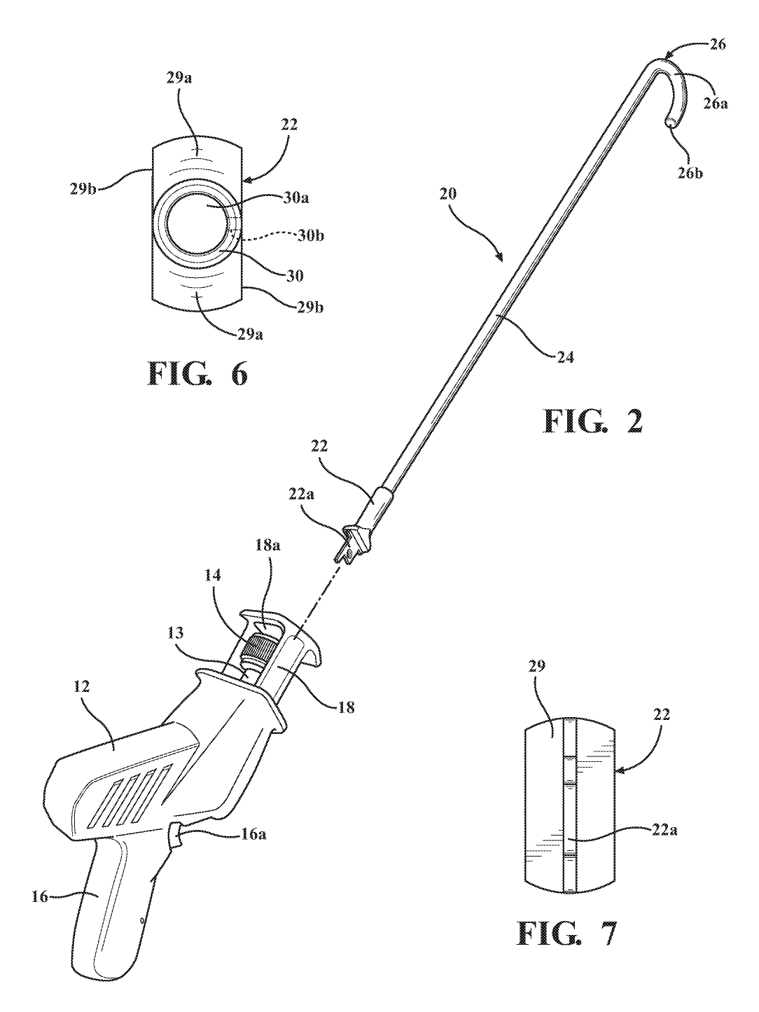

FIGS. 1 and 2 show a fruit thinning device 10 according to an example embodiment of the invention, being used to thin fruit F from a fruit tree branch B. Device 10 includes a handheld motor unit 12 with an electric motor that imparts linear reciprocating motion to a tool holder 14 in known manner. Motor unit 12 is preferably cordless, with a battery secured in the housing in known manner. Tool holder 14 may be a collet or chuck of known type, defining a socket or jaws on the end of a motor-driven reciprocating shaft 13, and capable of releasably clamping or securing the shank end of a tool. Device 10 further includes a stationary one-handed grip 16, a guard 18 with an opening 18a to allow a tool to be attached therethrough and to allow the attached tool to reciprocate freely. Pressing trigger 16a on grip 16 causes tool holder 14 to reciprocate within guard 18 in known manner, with variable speed depending on the extent the trigger is pressed.

The tool detachably mounted in tool holder 14 is a hook shaft 20 specially designed for thinning fruit from the branches of fruit trees. Hook shaft 20 includes a base portion 22 with a tool connector portion 22a (FIG. 2) that mates with tool holder 14 in known manner, and an upper shaft 24 with a terminal hook 26. Hook 26 has a bend 26a of approximately 180 degrees before terminating in tip 26b, so that tip 26b is approximately parallel to or even slightly angled in toward shaft 24.

The illustrated motor unit 12 may be, and preferably is, a commercially available one-handed saw of the type sold under trademarks such as Hackzall® and Sawzall®, which detachably mount reciprocating hack- or jig-saw blades in holder 14.

In the illustrated example, grip 16 defines a grip axis X1, while tool holder 14 defines a reciprocating tool axis X2 offset from and, in the illustrated example, non-parallel to the grip axis X1. This has been found by the inventor to be an extremely comfortable and efficient set of grip and tool angles for thinning fruit from fruit trees.

Hook shaft 20 is connected to motor unit 12 by inserting the connector portion 22a of base 22 into tool holder 14. Illustrated connector portion 22a takes the form of a known Hackzall® brand connector shank, with a small chamfered hole for receiving a spring detent pin to positively lock it in place once inserted into holder 14. Older or different known styles of chuck or collet connector can be substituted for illustrated connector portion 22a, depending on the make, model and age of the motor unit (if a commercially available model), and/or depending on the style or type of collet, chuck, or similar tool holder 14.

It will be understood that while a commercial model of motor unit 12 is shown in the illustrated example, custom units can be manufactured having different external configurations.

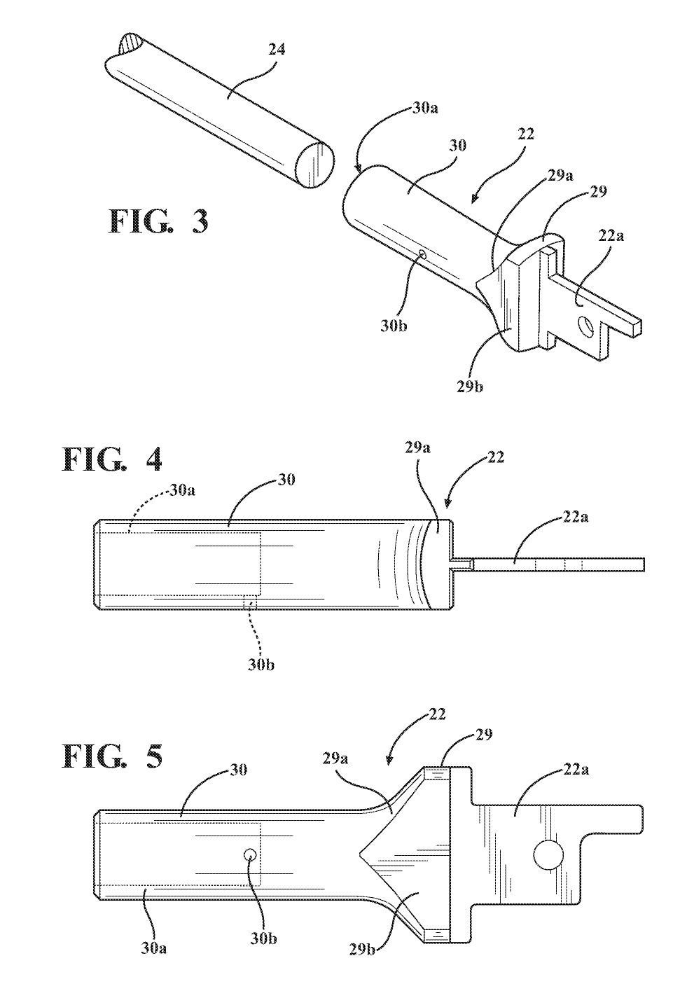

Referring next to FIGS. 3 through 7, hook shaft 20 can be made in one part, but in the illustrated example is shown in a preferred two-part configuration in which upper shaft portion 24 is assembled to a separate lower base portion 22. For example, the lower end of shaft portion 24 (FIG. 3) can be inserted into a socket portion 30 of base 22 and secured in place with temporary or permanent adhesive, by soldering or brazing, by swaging, or with a threaded interconnection. In the illustrated example, socket portion 30 includes a smooth blind bore 30a for receiving the lower end of shaft 24 along with a suitable small amount of solder. A small hole 30b is provided through the wall of socket 30 to help sweat out excess solder.

By using a two-part construction for hook shaft 20, multiple shaft portions 24 can be provided in different lengths and swapped out of base 22 as desired, allowing the end user to adjust the overall reach provided by tool 10. Example lengths for shaft portion 24 could be 12″ inches, 16″ inches, 20″ inches, and 24″ inches, without limitation. A preferred material for shaft section 24 is food grade stainless steel, although other materials are possible.

Base portion 22 includes a thickened guard or reinforcement 29 between connector 22a and socket 30, in the illustrated example having a roughly rectangular shape with rounded or radiused upper, lower, and frontal portions 29a, and side flats 29b. The shape and size of reinforcement 29 fits through, and may correspond to, the shape of opening 18a in motor unit guard 18a, if any.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention supported by the above disclosure should accordingly be construed within the scope of what it teaches and suggests to those skilled in the art, and within the scope of any claims that the above disclosure supports in this application or in any application claiming priority to this application.

I claim:

1. An apparatus for thinning fruit from fruit tree branches, comprising:
a handheld reciprocating motor unit comprising a stationary hand grip and a linearly reciprocating tool holder for detachably receiving and reciprocating an elongated hook shaft terminating in a fruit-removing hook.

2. The apparatus of claim 1, the fruit-removing hook has a bend sufficient to place a tip of the hook approximately parallel to or facing inwardly toward the shaft.

3. The apparatus of claim 1, the hand grip defines a generally vertical grip axis and the tool holder defines a reciprocating tool axis offset with respect to the grip axis.

4. The apparatus of claim 3, the reciprocating tool axis is angled in a non-parallel relationship to the grip axis.

5. The apparatus of claim 1, the hook shaft comprising an upper shaft portion and a lower base portion.

6. The apparatus of claim 1, further comprising multiple hook shaft portions of different lengths that may be swapped out to change the reach of the apparatus.

7. An apparatus for thinning fruit from fruit tree branches, comprising:
a handheld motor unit with an electric motor that imparts linear reciprocating motion to a tool holder, the motor unit having a stationary one-handed grip configured to allow a user to hold the motor unit with one hand;
a reciprocating shaft removably connected to the tool holder having a hook on its end for thinning fruit from the branches of fruit trees;
the tool holder comprising a guard with an opening configured to allow the reciprocating shaft to be removably attached therethrough and to allow the reciprocating shaft to reciprocate freely.

8. The apparatus of claim 7, the handheld motor unit is cordless with a battery secured in a housing.

9. The apparatus of claim 7, the tool holder comprising a collet or chuck defining a socket or jaws on the end of a motor-driven reciprocating shaft and capable of releasably clamping or securing the shank end of the reciprocating shaft.

10. The apparatus of claim 7, the reciprocating tool having an axis that is angled (non-parallel) with respect to an axis of the grip.

11. A method of thinning fruit from a fruit tree branch with a tool comprising;
detachably mounting a hook shaft into a guard of a tool holder on a handheld motor unit;
pressing a trigger on a grip on the motor unit causing the tool holder to reciprocate within the guard with variable speed depending on the extent the trigger is pressed; and
engaging unripe fruit on the tree branch with a hook end of the hook shaft to remove it from the tree branch.

12. The method of claim 11, the grip having an axis and the hook shaft having an axis, the method further comprising:
placing the grip axis substantially vertical and the hook tool axis 30-45 degrees inclined forward from vertical to engage the fruit.

13. The method of claim 11 further comprising swapping out multiple hook shafts of different lengths to adjust the reach of the tool.
